(19) United States
(12) Patent Application Publication
(10) Pub. No.: US 2004/0032177 A1
(43) Pub. Date: Feb. 19, 2004

(54) Noise-damped holding of an electric motor

(76) Inventors: Hartnut Nitzsche, Buehl (DE); Martin Huber, Oberkirch (DE); Cornelia Lula, Offenburg (DE); Michael Kupperer, Rheinau-Freistett (DE)

Correspondence Address: Striker, Striker & Stenby, 103 East Neck Road, Huntington, NY, 11743, US

(21) Appl. No.: 10/399,970

(22) PCT Filed: Jun. 28, 2002
(86) PCT No.: PCT/DE02/02393

(30) Foreign Application Priority Data
Aug. 29, 2001 (DE) 101421745

(51) Int. Cl. H02K 5/00

(52) U.S. Cl. 310/91; 310/89

(57) ABSTRACT

An electric motor is disclosed, which has a motor housing (15) and means, disposed on the motor housing (15), for retaining the motor housing (15) in the interior of a hollow-cylindrical receptacle part (13), in particular in a blower housing (10). To achieve a reliable seat of the electric motor (11) in the receptacle part (13) and to avoid damage to the receptacle part (13) as the motor housing (15) is press-fitted into it, the means for retaining the motor housing (15) in the receptacle part (13) are embodied as studs (21, 22), disposed in the motor housing (15), which as the motor housing (15) is press-fitted into the receptacle part (13) press against the inner wall (131) of the receptacle part (13) with nonpositive engagement (FIG. 1).

### PRIOR ART

The invention is based on an electric motor as generically defined by the preamble to claim 1.

One known electric motor of this type (German Patent Disclosure DE 197 06 852 A1), which drives a fan wheel, is inserted into a cup-shaped receiving housing, which has a cylindrical part and a radially extending bottom, and which is secured in a motor vehicle by means of screws to a fastening flange protruding radially from the end of the cylindrical part remote from the bottom. The means for retaining the motor housing in the cup-shaped receiving housing have a tubular retaining ring, which surrounds the circumference of the pole ring of the motor housing and is secured to the motor housing by shrink-fitting, adhesive bonding, riveting, or screwing, and a retaining disk, secured to the bottom of the receiving housing, that is joined to the retaining ring via axially extending, spring-elastic retaining ribs. The retaining ribs protruding radially from the retaining ring engage axial grooves that are milled into the inner wall face of the cylindrical part of the receiving housing. These retaining means enable a certain noise decoupling of the electric motor in the low-frequency range.

It is also known, while dispensing with damping between the electric motor and the receiving part that receives the electric motor, to form axial ribs onto the hollow-cylindrical receptacle part, made of plastic, in the inner wall region; these ribs rest with radial tension on the pole ring of the motor housing after the electric motor has been axially inserted. It has been found that upon assembly, because of the sharp end edges of the pole ring, which is produced as a stamped part, chips are sheared off from the axial ribs, causing a loss of quality of the installed unit that can be so severe as to cause rejection of the unit, either because of noise or blockage when the rotor is touched by the sheared-off chips, or because the seating of the electric motor in the receptacle part is inadequate when the axial retaining ribs are scraped off, or because of skewing of the electric motor from chip formation on one side, causing a fan blade seated on the rotor shaft to grind.

Advantages of the Invention

The electric motor of the invention having the characteristics of claim 1 has the advantage that because of the studs embodied on the motor housing, with gentle transitions in the axial direction to the housing surface, shearing off chips upon the assembly of the motor and the receptacle part is reliably precluded, since the studs slide along the inner wall face of the hollow-cylindrical receptacle part and always assure an adequate spacing of the surface of the motor housing from the inner wall face of the receptacle part, so that even sharp-edged shoulders on the motor housing, like those of a pole ring surrounding the rotor, do not touch the inner wall face. Production of the studs can be accomplished with little engineering effort or expense, especially if they are produced by bosses from the pole ring that are pressed out from the inside of the pole ring.

By the provisions recited in the other claims, advantageous refinements of and improvements to the electric motor defined by claim 1 are possible.

In a preferred embodiment of the invention, the pole ring of the motor housing put together from a pole ring and bearing plates comprises two rolled laminations resting on one another, and the studs are formed by pressed-through features made into the outer lamination. In this version of the pole ring, the studs can be realized very simply and economically in terms of production technology, because the sheet-metal blank for the outer lamination of the pole ring is first provided with pressed-through features that bulge outward, also known as beads, and then the two laminations are rolled into the shape of a ring, and the ends of the laminations are welded together.

In an advantageous embodiment of the invention, the studs are disposed in two axially spaced-apart rows, preferably with equal stud spacings, and the studs in the front row of studs, in terms of the insertion direction of the motor housing, have a lesser radial height than the studs in the rear row of studs. As a result, the electric motor can be inserted directly into the receptacle part, which is made of plastic and whose inner wall face, because of the necessary unmolding from the injection mold, has an embodiment corresponding to the jacket face of a cone, without the inner wall of the receptacle part first having to be subjected to postmachining.

In an advantageous embodiment of the invention, two axially spaced-apart rows of studs with equal stud spacings are provided, and the studs in both rows of studs have the same radial height, and the two rows of studs are rotated relative to one another. The rotational angle offset of the rows of studs relative to one another is equivalent to half the stud spacing within one row of studs. This has the advantage that it is unnecessary to define the direction of insertion of the electric motor into the receptacle part, and as a result there is greater freedom in terms of the structural design of the receptacle part. The jacket face of the receptacle part is adapted accordingly. In a fan or blower with a fan or blower housing and an integrated electric motor, whose motor housing has the above-described stud arrangement, the receptacle part is then designed, in accordance with an advantageous embodiment of the invention, such that axial indentations offset from one another by the same circumferential angle, are formed into the inner wall of the hollow-cylindrical receptacle part. The number of indentations is equal to the number of studs in each row of studs, and the rotational angle offset of the indentations is equivalent to the rotational angle spacing of the studs in each row of studs. The electric motor must then be inserted into the receptacle part in such a way that the studs located in the front row of studs, in terms of the insertion direction of the electric motor, dip into the indentations, while the studs located in the rear row of studs, in terms of the insertion direction, slide along the inner wall faces, outside the indentations. Once the assembly has been completed, the studs in both rows of studs press against the receptacle part with nonpositive engagement.

### DRAWING

The invention is described in further detail in the ensuing description in terms of exemplary embodiments shown in the drawing. Shown are:

FIG. 1, a longitudinal section through a blower, with a blower housing, an integrated electric motor, and a blower wheel driven by the electric motor;

FIG. 2, an enlarged view of the detail marked II in FIG. 1 of a modified pole ring of a motor housing;

FIG. 3, a section taken along the line III-III in FIG. 4 or 5 of an assembled unit comprising a receptacle part of the blower housing and the pole ring of the motor housing, in a further exemplary embodiment;

FIG. 4, a section taken along the line IV-IV in FIG. 3;

FIG. 5, a section taken along the line V-V in FIG. 3.

### DESCRIPTION OF THE EXEMPLARY EMBODIMENTS

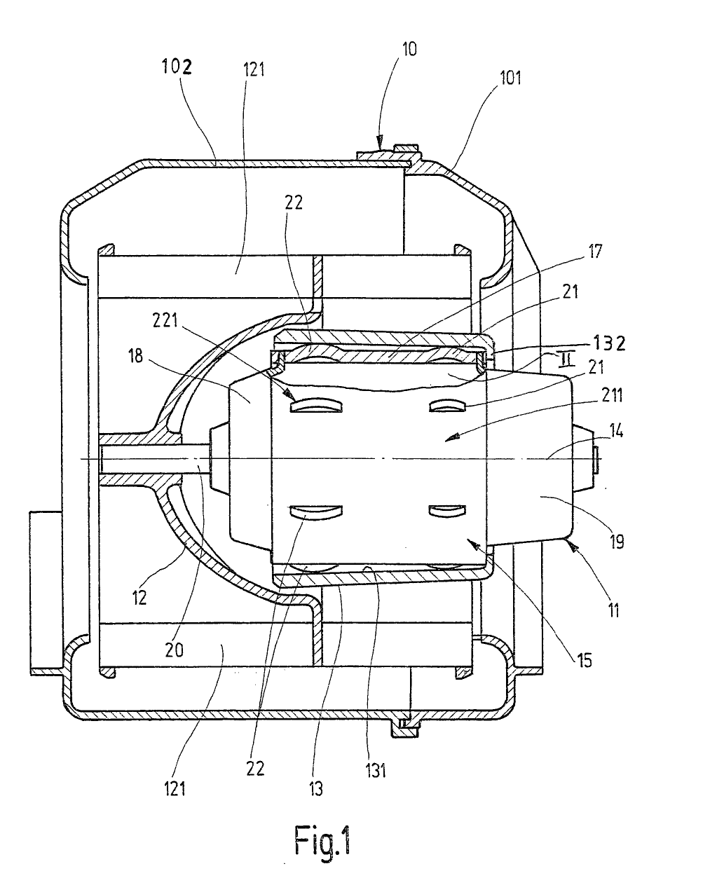

The blower shown in longitudinal section in FIG. 1, for instance for a motor vehicle air condition, has a blower housing 10 and an electric motor 11, integrated with the blower housing 10, as well as a blower wheel 12 driven by the electric motor 11. The blower housing 10, manufactured as a plastic injection-molded part, is embodied in two parts, and once the electric motor 11 and the blower wheel 12 have been assembled, the two housing parts 101 and 102 are pressed into one another. A cylindrical receptacle part 13 is secured, preferably by being formed on, coaxially with the housing axis 14 to one housing part 101, and the electric motor 11 is inserted into this receptacle part and retained therein by means described below.

The electric motor 11, shown in a side view and partly in section, has a motor housing 15, which in a known manner includes a pole ring 17, axially covering the armature or rotor of the electric motor 11, and two bearing plates 18, 19 connected to the pole ring 17; each bearing plate 18, 19 protrudes from a respective face end of the pole ring 17. The rotor, not visible in FIG. 1, is received in a manner fixed against relative rotation on a rotor shaft 20 that is supported rotatably relative to the two bearing plates 18, 19 and past which one bearing plate 18 protrudes axially. The blower wheel 12 is seated in a manner fixed against relative rotation on this axially protruding portion of the rotor shaft 20.

As the means for retaining the motor housing 15 in the receptacle part 13 of the blower housing 10, studs 21, 22 are provided, formed by embossing from the ring material and protruding from the pole ring in the region of the pole ring 17; after the electric motor 11 has been press-fitted into the receptacle part 13, these studs press with tension against the inner wall face 131 of the receptacle part 13. The studs 21 are arranged in a first stud row 211, and the studs 22 are arranged in a second stud row 221. The two stud rows 211 and 221 extend once around the circumference of the pole ring 17, with axial spacing from one another, and the spacing of the studs 21 and 22 in each stud row 211 and 221, respectively, in terms of the circumferential direction is preferably equal. Since the inner wall face 131 of the receptacle part 13, for the sake of unmolding from the injection mold in the production of the blower housing 10, forms a widening unmolding cone, the studs 21 in the front stud row 211, in terms of the insertion direction of the motor housing 15 into the receptacle part 13, are embodied with a lesser radial height than the studs 22 in the rear stud row 221 in the insertion direction. This assures that in the front and rear regions of the pole ring 17, the electric motor 11 rests with approximately equal tension against the inner wall face 131 of the receptacle part 13. On the end of the receptacle part 13, an annular stop 132 protruding radially past the inner wall face 131 is formed, against which the pole ring 17 strikes at the end of the process of press-fitting into the receptacle part 13.

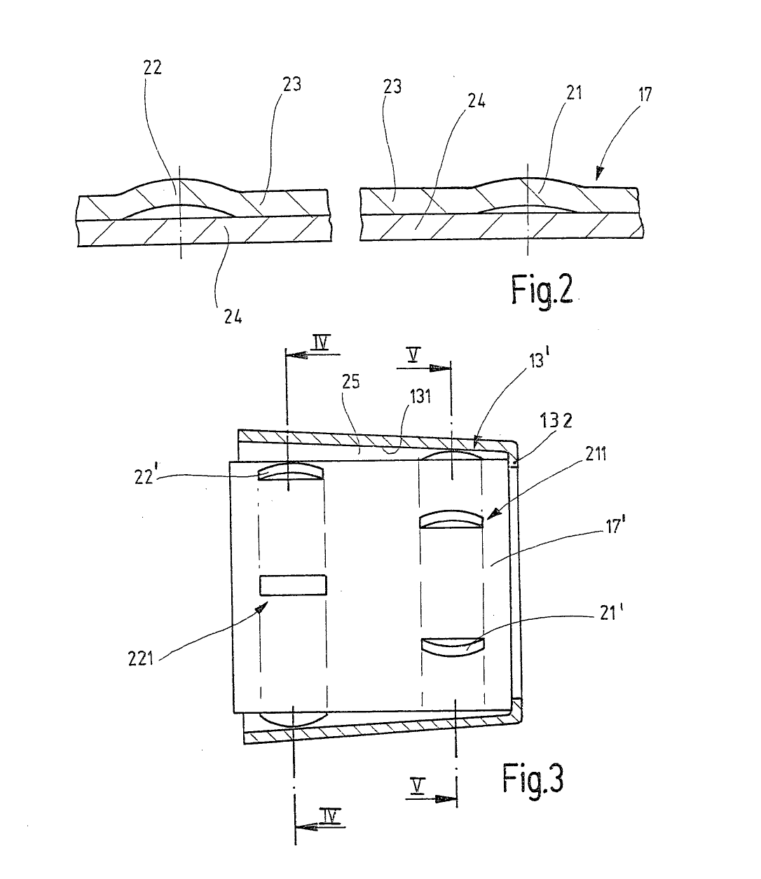

In the exemplary embodiment of FIG. 1, the pole ring 17 is a solid ring of material, in which the studs 21, 22 are pressed through outward from the inside. To make the production process of the studs 21, 22 more favorable, the pole ring 17 is put together, as shown in fragmentary form in FIG. 2, from two rolled metal sheets 23, 24 resting on one another, of which the outer sheet 23 carries the studs 21, 22. Before the outer sheet 23 is rolled up, the studs 21, 22 are formed in the sheet blank for the outer sheet 23 by indenting of outward-oriented beads, or by pressed-through features. Next, the sheet-metal blanks are rolled. If necessary, to increase the resistance to shifting or rotation of the sheets 23, 24, the rolled sheets 23, 24 can be welded together at the ends of the sheets.

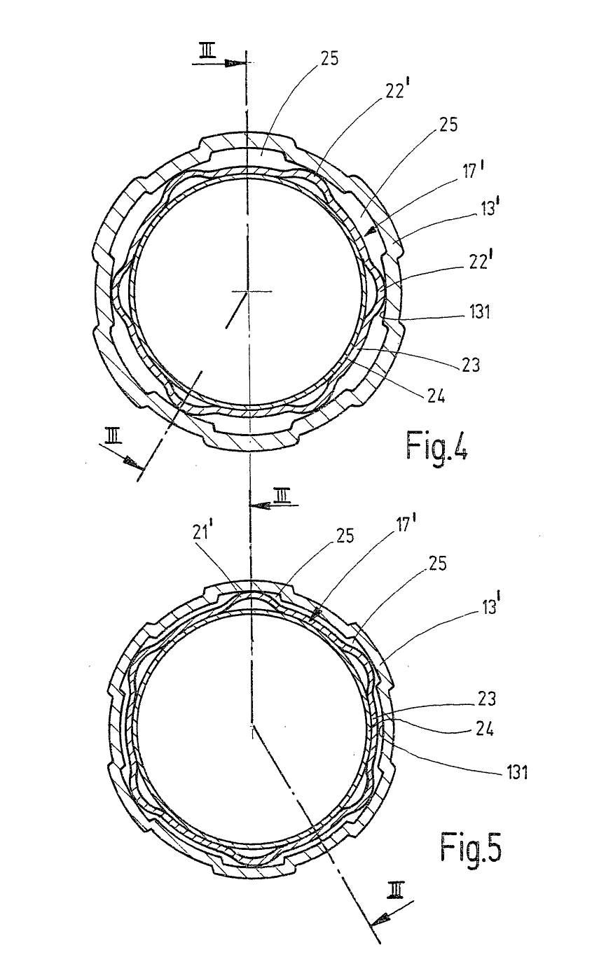

In FIGS. 3-5, a further exemplary embodiment of a pole ring 17′ of the motor housing 15, the pole ring being inserted into a receptacle part 13 is shown in various sectional views. The pole ring 17′ is again put together from two rolled sheets 23, 24, as the sectional views in FIGS. 4 and 5 show. It is understood that it is also possible for the pole ring 17 to be embodied in one piece, and for the studs 21, 22 to be created by embossing accordingly. In the outer sheet 23 of the pole ring 17′, once again the studs 21 are embossed in a stud row 211 and the studs 22 are embossed in the stud row 221 spaced apart from it, but with the difference that the studs 21′, 22′ in the two stud rows 211 and 221 have the same radial height, and the stud rows 211 and 221 are offset from one another by a rotational angle that equals approximately half the spacing of the studs 21′ in the stud row 211 or of the studs 22′ in the stud row 221. As seen particularly from FIGS. 4 and 5, the receptacle part 13′ is provided with axial indentations 25 offset from one another by the same circumferential angle. The number of indentations 25 equals the number of studs 21′ and 22′ in each respective stud row 211 and 221, and the rotational angle offset of the indentations 25 corresponds to the rotary angle spacing of the studs 21′ and 22′ in each stud row 211 and 221, respectively. In the exemplary embodiment of FIGS. 4 and 5, the indentations 25 are formed by inwardly embossed features on the inner wall face 131, which widens conically from the stop 132, of the receptacle part 13′. A cylindrical embodiment of the inner wall face 131 is possible.

Upon installation of the electric motor 11 in the blower housing 10, the electric motor 11 is placed rotated against the face end of the receptacle part 13′ remote from the stop 132 in such a way that the studs 21′ lined up in the stud row 211 at the front in the insertion direction are aligned with the indentations 25 in the receptacle part 13′. If the pole ring 17′ is now press-fitted into the receptacle part 13′, the studs 21′ in the front stud row 211 slide in the indentations 25, and the studs 22′ in the rear stud row 221 slide along the inner wall face 131 outside the indentations 25 and press increasingly against the receptacle part 13′. Embodying the studs 21′ and 22′ with the same radial height, but with a stud offset in the two stud rows 211, 221 has the advantage that for the insertion of the motor housing 15 into the receptacle part 13′, no insertion direction for the electric motor 11 has to be defined; that is, the electric motor 11 can be inserted, turned around 180°, into the receptacle part 13′.

1. An electric motor, having a motor housing (15) and having means, disposed on the motor housing (15), for retaining the motor housing (15) in the interior of a hollow-cylindrical receptacle part (13; 13′), characterized in that the means for retention have studs (21, 22; 21′, 22′), disposed on the motor housing (15), for pressing against the inner wall (131) of the receptacle part (13; 13′) with nonpositive engagement.

2. The electric motor of claim 1, in which the motor housing (15) has a pole ring (17; 17′), surrounding a rotor (20), and two bearing plates (18, 19), connected to the pole ring (17; 17′), for rotational support of the rotor (20), characterized in that the disposition of the studs (21, 22; 21′, 22′) is done on the pole ring (17; 17′).

3. The electric motor of claim 2, characterized in that the studs (21, 22; 21′, 22′) are formed by bosses in the pole ring (17; 17′).

4. The electric motor of claim 3, characterized in that the pole ring (17′) comprises two rolled laminations (23, 24) resting on one another, and that the studs (21, 22; 21′, 22′) are formed by pressed-through features made into the outer lamination (23).

5. The electric motor of one of claims 1-4, characterized in that the studs (21, 22; 21′, 22′) are disposed, preferably equidistantly, in at least one of rows (211, 222) extending all the way around the pole ring (17; 17′).

6. The electric motor of claim 5, characterized in that two axially spaced-apart rows (211, 222) of studs (21, 22; 21′, 22′) with equal stud spacings are provided.

7. The electric motor of claim 6, characterized in that the rows of studs (211, 222) are rotated relative to one another in the circumferential direction.

8. The electric motor of claim 6 or 7, characterized in that the studs (21) in the front row (211) of studs, in terms of the insertion direction of the motor housing (15), have a lesser radial height than the studs (22) in the rear row (221) of studs.

9. The electric motor of claim 7, characterized in that the studs (21′, 22′) in both stud rows (211, 222) have the same radial height, and the rotational angle offset of the stud rows (211, 222) from one another is equal to half the stud spacing within one stud row (211, 222).

10. A blower, having a blower housing (10) and an electric motor (11) of claim 8 integrated with the blower housing (10), characterized in that the receptacle part (13) is embodied on the blower housing (10), preferably formed onto it, and has an inner wall face (131) forming an unmolding cone, and that the electric motor (11) is inserted into the receptacle part (13) in such a way that the stud row (211) having the studs (21) with the lesser radial heights is located in a region of the receptacle part (13) having a smaller inside diameter than the stud row (221) having the studs (22) with the greater radial height.

11. A blower having a blower housing (10) and an electric motor (11) of claim 9 integrated with the blower housing (10), characterized in that the receptacle part (13′) is embodied on the blower housing (10), preferably formed onto it, and the inner wall face (131) of the receptacle part (13′) has indentations (25), extending in the axial direction, that are offset from one another by the same circumferential angle, and whose number corresponds to the number of studs (21′, 22′) in each stud row (211, 222), and whose rotational angle offset is equivalent to the rotational angle offset of the stud rows (211, 222).
